(19) United States
(12) Patent Application Publication
(10) Pub. No.: US 2026/0213183 A1
(43) Pub. Date: Jul. 23, 2026

(54) NON-AQUEOUS ELECTROLYTE SECONDARY BATTERY

(71) Applicant: Panasonic Energy Co., Ltd., Moriguchi-shi, Osaka (JP)

(72) Inventors: Takayuki Ishikawa, Osaka (JP); Noriko Fukamichi, Osaka (JP)

(73) Assignee: Panasonic Energy Co., Ltd., Moriguchi-shi, Osaka (JP)

(21) Appl. No.: 19/140,698

(22) PCT Filed: Dec. 7, 2023
(86) PCT No.: PCT/JP2023/043789

§ 371 Date: Jun. 18, 2025

(30) Foreign Application Priority Data
Dec. 27, 2022 (JP) 2022-209765

(51) Int. Cl. H01M 4/525; H01M 4/02; H01M 10/052

(52) U.S. Cl. CPC H01M 4/525; H01M 10/052; H01M 2004/021; H01M 2004/028

(57) ABSTRACT

The non-aqueous electrolyte secondary battery comprises: a positive electrode; a negative electrode; and a non-aqueous electrolyte. The positive electrode has: a positive electrode current collector; and a positive electrode mixture layer formed on the surface of the positive electrode current collector. The positive electrode mixture layer includes: a first positive electrode active material; and a second positive electrode active material. The particle size ratio R1/R2 of the average particle size R1 of the first positive electrode active material and the average particle size R2 of the second positive electrode active material is 3 to 9, the volume ratio V1/V2 of the volume V1 of the first positive electrode active material and the volume V2 of the second positive electrode active material is 3 to 9, and the density of the positive electrode mixture layer is 3.35 g/cm³ to 3.70 g/cm³.

### TECHNICAL FIELD

The present disclosure relates to a non-aqueous electrolyte secondary battery.

### BACKGROUND ART

A lithium-transition metal composite oxide containing Ni, Co., and the like has been conventionally used as a positive electrode active material with high capacity. For example, Patent Literature 1 discloses art in which use of a positive electrode active material containing two lithium cobaltates having different composition and average particle diameters mixed at a predetermined volume ratio improves a battery capacity and rate characteristics.

### CITATION LIST

### Patent Literature

PATENT LITERATURE 1: Japanese Unexamined Patent Application Publication No. 2006-156004

### SUMMARY

Further increase in capacity has been required in recent years, and there have been investigations on increase in a proportion of a positive electrode active material in a positive electrode mixture layer. However, an excessively reduced content of a binder in the positive electrode mixture layer may cause peeling of the positive electrode mixture layer from a positive electrode current collector. Patent Literature 1 does not investigate the peeling of the positive electrode mixture layer, and still has room for improvement.

It is an advantage of the present disclosure to provide a non-aqueous electrolyte secondary battery with a high capacity and inhibited peeling of the positive electrode mixture layer.

A non-aqueous electrolyte secondary battery of an aspect of the present disclosure comprises: a positive electrode; a negative electrode; and a non-aqueous electrolyte, wherein the positive electrode has a positive electrode current collector and a positive electrode mixture layer formed on a surface of the positive electrode current collector, the positive electrode mixture layer includes a first positive electrode active material and a second positive electrode active material having a smaller average particle diameter than the first positive electrode active material, a particle diameter ratio R1/R2 between an average particle diameter R1 of the first positive electrode active material and an average particle diameter R2 of the second positive electrode active material is greater than or equal to 3 and less than or equal to 9, a volume ratio V1/V2 between a volume V1 of the first positive electrode active material and a volume V2 of the second positive electrode active material is greater than or equal to 3 and less than or equal to 15, and a density of the positive electrode mixture layer is greater than or equal to 3.35 g/cm³ and less than or equal to 3.70 g/cm³.

The non-aqueous electrolyte secondary battery according to the present disclosure has a high capacity and excellent adhesiveness of the positive electrode mixture layer.

### BRIEF DESCRIPTION OF DRAWING

FIG. 1 is an axial sectional view of a cylindrical secondary battery of an example of an embodiment.

### DESCRIPTION OF EMBODIMENTS

Hereinafter, an example of an embodiment of a cylindrical secondary battery according to the present disclosure will be described in detail with reference to the drawing. In the following description, specific shapes, materials, values, directions, and the like, which are examples for facilitating understanding of the present invention, may be appropriately modified with specifications of secondary batteries. Hereinafter, a cylindrical secondary battery in which a wound electrode assembly is housed in a cylindrical exterior body will be exemplified, but the electrode assembly is not limited to the wound electrode assembly, and may be a stacked electrode assembly in which a plurality of positive electrodes and a plurality of negative electrodes are alternately stacked one by one via a separator. The exterior body is not limited to the cylindrical exterior body, and may be, for example, a rectangular exterior body or a coin-shaped exterior body. The exterior body may be a pouch composed of laminated sheets including a metal layer and a resin layer. The description “a numerical value (A) to a numerical value (B)” herein means greater than or equal to the value (A) and less than or equal to the value (B).

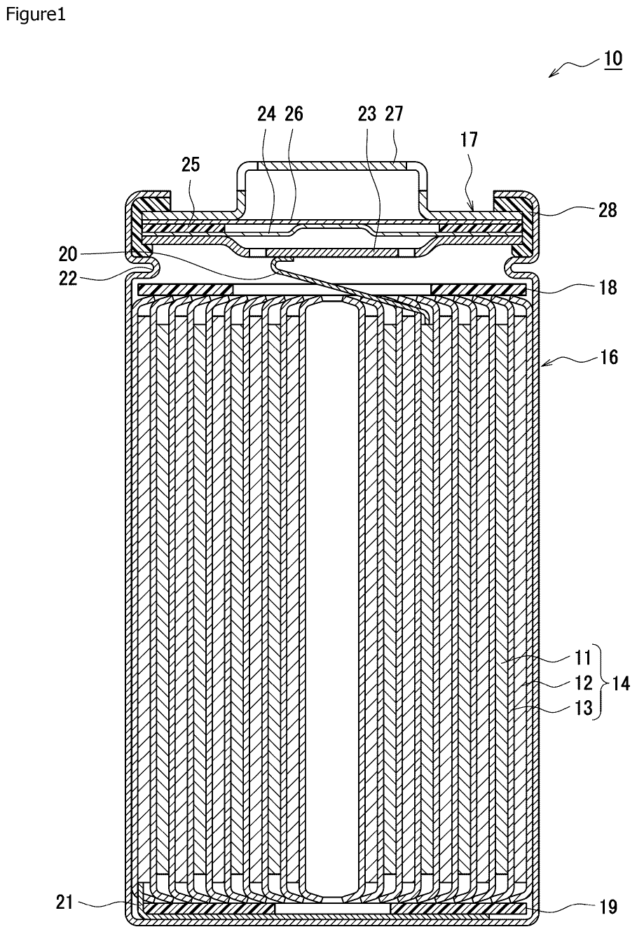

FIG. 1 is a sectional view of a cylindrical secondary battery 10 of an example of an embodiment. As illustrated in FIG. 1, the secondary battery 10 comprises a wound electrode assembly 14, a non-aqueous electrolyte, and an exterior housing can 16 housing the electrode assembly 14 and the non-aqueous electrolyte. The electrode assembly 14 has a positive electrode 11, a negative electrode 12, and a separator 13, and has a wound structure in which the positive electrode 11 and the negative electrode 12 are spirally wound via the separator 13. The exterior housing can 16 is a bottomed cylindrical metallic container having an opening on one side in an axial direction, and the opening of the exterior housing can 16 is capped with a sealing assembly 17. Hereinafter, for convenience of description, the sealing assembly 17 side of the battery will be described as the upper side, and the bottom side of the exterior housing can 16 will be described as the lower side.

All of the positive electrode 11, the negative electrode 12, and the separator 13 that constitute the electrode assembly 14 are an elongated band-shaped body, and spirally wound to be alternately stacked in a radial direction of the electrode assembly 14. The separator 13 separates the positive electrode 11 and the negative electrode 12 each other. To prevent precipitation of lithium, the negative electrode 12 is formed to be one size larger than the positive electrode 11. That is, the negative electrode 12 is formed to be longer than the positive electrode 11 in a longitudinal direction and a width direction (short direction). Two of the separator 13 are formed to be one size larger than at least the positive electrode 11, and disposed to sandwich the positive electrode 11. The electrode assembly 14 comprises: a positive electrode lead 20 connected to the positive electrode 11 by welding or the like; and a negative electrode lead 21 connected to the negative electrode 12 by welding or the like.

Insulating plates 18 and 19 are disposed on the upper and lower sides of the electrode assembly 14, respectively. In the example illustrated in FIG. 1, the positive electrode lead 20 extends through a through hole in the insulating plate 18 toward a side of the sealing assembly 17, and the negative electrode lead 21 extends along an outside of the insulating plate 19 toward the bottom side of the exterior housing can 16. The positive electrode lead 20 is connected to a lower surface of an internal terminal plate 23 of the sealing assembly 17 by welding or the like, and a cap 27, which is a top plate of the sealing assembly 17 electrically connected to the internal terminal plate 23, becomes a positive electrode terminal. The negative electrode lead 21 is connected to a bottom inner surface of the exterior housing can 16 by welding or the like, and the exterior housing can 16 becomes a negative electrode terminal.

A gasket 28 is provided between the exterior housing can 16 and the sealing assembly 17 to achieve sealability inside the battery. On the exterior housing can 16, a grooved portion 22 in which a part of a side surface portion thereof projects inward for supporting the sealing assembly 17 is formed. The grooved portion 22 is preferably formed in a circular shape along a circumferential direction of the exterior housing can 16, and supports the sealing assembly 17 with the upper surface thereof. The sealing assembly 17 is fixed on the upper part of the exterior housing can 16 with the grooved portion 22 and with an end portion of the opening of the exterior housing can 16 caulked to the sealing assembly 17.

The sealing assembly 17 has a stacked structure of the internal terminal plate 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected at respective central parts thereof, and the insulating member 25 is interposed between the respective circumferential parts thereof. If the internal pressure of the battery increases due to abnormal heat generation, the lower vent member 24 is deformed so as to push the upper vent member 26 up toward the cap 27 side and breaks, and thereby a current pathway between the lower vent member 24 and the upper vent member 26 is cut off. If the internal pressure further increases, the upper vent member 26 breaks, and gas is discharged through the opening portion of the cap 27.

Hereinafter, the positive electrode 11, the negative electrode 12, the separator 13, and the non-aqueous electrolyte, which constitute the secondary battery 10, particularly the positive electrode 11, will be described in detail.

### [Positive Electrode]

The positive electrode 11 has a positive electrode current collector and a positive electrode mixture layer formed on a surface of the positive electrode current collector. The positive electrode mixture layer is preferably formed on both surfaces of the positive electrode current collector. For the positive electrode current collector, a foil of a metal stable within a potential range of the positive electrode 11, such as aluminum and an aluminum alloy, a film in which such a metal is disposed on a surface layer, or the like can be used.

The positive electrode mixture layer includes, for example, a positive electrode active material, a binder and a conductive agent. A content of the positive electrode active material in the positive electrode mixture layer is, for example, greater than or equal to 85 mass % and less than or equal to 99 mass % relative to a total mass of the positive electrode mixture layer. The positive electrode 11 can be produced by, for example, applying a positive electrode mixture slurry including the positive electrode active material, the binder, the conductive agent and the like on the surface of the positive electrode current collector, drying the coating film, and then rolling the coating film by using a roller or the like.

A density of the positive electrode mixture layer is preferably greater than or equal to 3.35 g/cm³ and less than or equal to 3.70 g/cm³, and more preferably greater than or equal to 3.40 g/cm³ and less than or equal to 3.65 g/cm³. The density of the positive electrode mixture layer is obtained by dividing a mass of the positive electrode mixture layer by a mass of the positive electrode mixture layer.

Examples of the conductive agent included in the positive electrode mixture layer include carbon-based particles such as carbon black (CB), acetylene black (AB), Ketjenblack, carbon nanotube (CNT), graphene, and graphite. These may be used singly, or may be used in combination of two or more. A content of the conductive agent is, for example, greater than or equal to 0.1 mass % and less than or equal to 10 mass % relative to the mass of the positive electrode active material.

Examples of the binder included in the positive electrode mixture layer include a fluororesin such as polytetrafluoroethylene (PTFE) and polyvinylidene fluoride (PVDF), a polyimide resin, an acrylic resin, a polyolefin resin, and polyacrylonitrile (PAN). These may be used singly, or may be used in combination of two or more thereof. A content of the binder is preferably greater than or equal to 0.1 mass % and less than or equal to 5 mass %, more preferably greater than or equal to 0.1 mass % and less than or equal to 1 mass %, and particularly preferably greater than or equal to 0.1 mass % and less than or equal to 0.5 mass % relative to the mass of the positive electrode active material. Reducing the content of the binder can increase the content of the positive electrode active material, resulting in increased battery capacity.

The positive electrode active material included in the positive electrode mixture layer is a lithium-transition metal composite oxide, for example. The lithium-transition metal composite oxide may have, for example, a layered structure belonging to the space group R-3m, a layered structure belonging to the space group C2/m, and the like. Among them, the layered structure belonging to the space group R-3m is preferable in terms of the higher capacity, the stability of the crystal structure, and the like. The layered structure of the lithium-transition metal composite oxide may include a transition metal layer, a Li layer, and an oxygen layer.

The lithium-transition metal composite oxide is represented by, for example, the general formula LiₐNiₓM1_{y}M2_{z}O_{b}, wherein 0.9≤a≤1.2, 0.33≤x≤0.96, 0≤y≤0.67, 0≤z≤0.67, 1.9≤b≤2.1, x+y+z=1, M1 represents greater than or equal to one element selected from the group consisting of Co, Al and Mn. and M2 represents greater than or equal to one element selected from the group consisting of Nb, Ti, Zr, W, and Si. The mole fractions of the metal elements contained in the lithium-transition metal composite oxide may be measured by inductively coupled plasma (ICP) atomic emission spectrometry, for example.

The lithium-transition metal composite oxide includes secondary particles each formed by aggregation of primary particles, for example. A particle diameter of the primary particles constituting the secondary particles of the lithium-transition metal composite oxide is, for example, greater than or equal to 0.02 μm and less than or equal to 2 μm. The particle diameter of the primary particles is measured as a diameter of a circumscribed circle in a particle image observed with a scanning electron microscope (SEM).

The positive electrode mixture layer includes a first positive electrode active material and a second positive electrode active material having a smaller average particle diameter than the first positive electrode active material. A particle diameter ratio R1/R2 between an average particle diameter R1 of the first positive electrode active material and an average particle diameter R2 of the second positive electrode active material is preferably greater than or equal to 3 and less than or equal to 9, and more preferably greater than or equal to 4 and less than or equal to 8. The average particle diameter herein means a median diameter (D50) of secondary particles on a volumetric basis. The D50 means a particle diameter at which a cumulative frequency is 50% from a smaller particle diameter side in a particle size distribution on a volumetric basis. The particle size distribution of the secondary particles of the lithium-transition metal composite oxide can be measured by using a laser diffraction-type particle size distribution measuring device (for example, MT3000II, manufactured by MicrotracBEL Corp.) with water as a dispersion medium. The average particle diameter R1 is, for example, greater than or equal to 1 μm and less than or equal to 50 μm. The average particle diameter R2 is, for example, greater than or equal to 0.2 μm and less than or equal to 10 μm.

A volume ratio V1/V2 between a volume V1 of the first positive electrode active material and a volume V2 of the second positive electrode active material is preferably greater than or equal to 3 and less than or equal to 15, and more preferably greater than or equal to 4 and less than or equal to 12.

Controlling the density of the positive electrode mixture layer to be within the range of greater than or equal to 3.35 g/cm³ and less than or equal to 3.70 g/cm³ and using the first positive electrode active material and the second positive electrode active material that satisfy the particle diameter ratio R1/R2 of greater than or equal to 3 and less than or equal to 9 and the volume ratio V1/V2 of greater than or equal to 3 and less than or equal to 15 allow the binder to spread among the positive electrode active material, which may achieve both the increase in capacity and inhibition of peeling of the positive electrode mixture layer.

### [Negative Electrode]

The negative electrode 12 has, for example, a negative electrode current collector and a negative electrode mixture layer formed on a surface of the negative electrode current collector. The negative electrode mixture layer is preferably formed on both surfaces of the negative electrode current collector. For the negative electrode current collector, a foil of a metal stable within a potential range of the negative electrode, such as copper and a copper alloy, a film in which such a metal is disposed on a surface layer thereof, and the like may be used.

The negative electrode mixture layer includes, for example, a negative electrode active material and a binder. A content of the negative electrode active material in the negative electrode mixture layer is, for example, greater than or equal to 80 mass % and less than or equal to 99 mass % relative to a total mass of the negative electrode mixture layer. The negative electrode 12 can be produced by, for example, applying a negative electrode mixture slurry including the negative electrode active material, the binder, and the like on the surface of the negative electrode current collector, drying the coating film, and then compressing the coating film by using a roller or the like.

The negative electrode active material included in the negative electrode mixture layer is not particularly limited as long as it can reversibly occlude and release Li ions, and carbon materials such as graphite are typically used. The graphite may be any of natural graphite such as flake graphite, massive graphite, and amorphous graphite, and artificial graphite such as massive artificial graphite and graphitized mesophase carbon microbead. As the negative electrode active material, a metal that forms an alloy with Li, such as Si and Sn, a metal compound including Si, Sn, and the like, a lithium-titanium composite oxide, and the like may also be used. For example, a silicon oxide represented by SiOₓ (“x” represents greater than or equal to 0.5 and less than or equal to 1.6), a silicon-containing material in which Si fine particles are dispersed in a lithium silicate phase represented by Li_{2y}SiO_{(2+y)} (0<y<2), a silicon-containing material in which Si fine particles are dispersed in a carbon phase, or the like may be used in combination with the graphite.

Example of the binder included in the negative electrode mixture layer include styrene-butadiene rubber (SBR), nitrile-butadiene rubber (NBR), carboxymethylcellulose (CMC) or a salt thereof (which may be CMC-Na, CMC-K, CMC-NH₄, and the like, or a partially neutralized salt), polyacrylic acid (PAA) or a salt thereof (which may be PAA-Na, PAA-K, and the like, or a partially neutralized salt), and polyvinyl alcohol (PVA). These may be used singly, or may be used in combination of two or more thereof.

### [Separator]

For the separator 13, a porous sheet having an ion permeation property and an insulation property, or the like is used, for example. Specific examples of the porous sheet include a fine porous thin film, a woven fabric, and a nonwoven fabric. As a material for the separator, a polyolefin resin such as polyethylene and polypropylene, cellulose, or the like is preferable. The separator 13 may be a stacked body having a cellulose fiber layer and a thermoplastic resin fiber layer such as an olefin resin. The separator 13 may be a multi-layer separator including a polyethylene layer and a polypropylene layer, or a separator in which a material such as an aramid resin and ceramic is applied on a surface of the separator 13 may be used.

### [Non-Aqueous Electrolyte]

The non-aqueous electrolyte has lithium-ion conductivity. The non-aqueous electrolyte may be a liquid electrolyte (an electrolyte liquid) or may be a solid electrolyte.

The liquid electrolyte (the electrolyte liquid) includes a non-aqueous solvent and an electrolyte salt dissolved in the non-aqueous solvent. For the non-aqueous solvent, esters, ethers, nitriles such as acetonitrile, amides such as dimethylformamide, a mixed solvent of two or more thereof, or the like may be used, for example. The non-aqueous solvents may contain a halogen-substituted derivative in which the hydrogen atoms of these solvents are at least partially replaced with a halogen atom such as fluorine.

Examples of the esters include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as γ-butyrolactone and γ-valerolactone; and chain carboxylates such as methyl acetate, ethyl acetate, propyl acetate, methyl propionate (MP), and ethyl propionate.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted derivative, fluorinated cyclic carbonates such as fluoroethylene carbonate (FEC), fluorinated chain carbonates, fluorinated chain carboxylates such as methyl fluoropropionate (FMP), and the like are preferably used.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, and “n” represents 1 or 2), LiB₁₀Cl₁₀, LiCl, LiBr, LiI, lithium chloroborane, a lithium lower aliphatic carboxylate, borate salts such as Li₂B₄O₇ and Li(B(C₂O₄)F₂), and imide salts such as LiN(SO₂CF₃)₂ and LiN(CₗF₂ₗ₊₁SO₂)(CₘF₂ₘ₊₁SO₂) {“l” and “m” represent integers of greater than or equal to 1}. These lithium salts may be used singly, or a plurality of types thereof may be mixed for use. Among them, LiPF₆ is preferably used from the viewpoints of ion conductivity, electrochemical stability, and the like. A concentration of the lithium salt is preferably greater than or equal to 0.8 mol and less than or equal to 1.8 mol per litter of the solvent.

As the solid electrolyte, a solid or gel polymer electrolyte, an inorganic solid electrolyte, and the like may be used, for example. For the inorganic solid electrolyte, a known material for an all-solid lithium-ion secondary battery or the like (for example, an oxide-type solid electrolyte, a sulfide-type solid electrolyte, a halogen-type solid electrolyte, and the like) may be used. The polymer electrolyte includes the lithium salt and a matrix polymer, or includes the non-aqueous solvent, the lithium salt, and a matrix polymer, for example. As the matrix polymer, a polymer material that absorbs the non-aqueous solvent to gel is used, for example. Examples of the polymer material include a fluororesin, an acrylic resin, and a polyether resin.

### EXAMPLES

Hereinafter, the present disclosure will be further described with Examples, but the present disclosure is not limited to these Examples.

### Example 1-1

### [Production of Positive Electrode]

As a first positive electrode active material, a lithium-transition metal composite oxide having an average particle diameter of 10.2 μm and composition represented by LiNi_{0.88}Co_{0.04}Mn_{0.08}O₂ was used. As a second positive electrode active material, a lithium-transition metal composite oxide having an average particle diameter of 2.0 μm and composition represented by LiNi_{0.88}Co_{0.07}Al_{0.05}O₂ was used. Therefore, a particle diameter ratio R1/R2 was 5.1. The first positive electrode active material and the second positive electrode active material were mixed so that a volume ratio V1/V2 was 9.3, and this mixture was used as a positive electrode active material. This positive electrode active material, carbon black, and polyvinylidene fluoride (PVDF) were mixed at a mass ratio of 100:0.5:0.7, and an appropriate amount of N-methyl-2-pyrolidone (NMP) was added as a dispersion medium to prepare a positive electrode mixture slurry. Then, this positive electrode mixture slurry was applied on both surfaces of a positive electrode current collector composed of aluminum foil, and the coating film was dried, rolled, and cut to a predetermined electrode size to produce a positive electrode in which a positive electrode mixture layer is formed on both the surfaces of the positive electrode current collector. A density of the positive electrode mixture layer was 3.50 g/cm³. An exposed portion where the surface of the positive electrode current collector was exposed was provided on a part of the positive electrode.

### [Production of Negative Electrode]

Mixing 100 parts by mass of artificial graphite, 1 part by mass of sodium carboxymethylcellulose (CMC-Na), 1.2 parts by mass of styrene-butadiene rubber (SBR), and water was performed to prepare a negative electrode mixture slurry. Then, this negative electrode mixture slurry was applied on both surfaces of a negative electrode current collector composed of copper foil, the coating film was dried and rolled, and then cut to a predetermined electrode size to produce a negative electrode in which a negative electrode mixture layer is formed on both surfaces of the negative electrode current collector. An exposed portion where the surface of the negative electrode current collector was exposed was provided on a part of the negative electrode.

### [Preparation of Non-Aqueous Electrolyte]

Ethylene carbonate (EC) and ethyl methyl carbonate (EMC) were mixed at a volume ratio of 3:7 to prepare a mixed solvent. Into this mixed solvent, lithium hexafluorophosphate (LiPF₆) was dissolved at a concentration of 1 mol/L to prepare a non-aqueous electrolyte.

### [Production of Test Cell]

A positive electrode lead made of aluminum was attached to the exposed portion of the positive electrode, and a negative electrode lead made of nickel was attached to the exposed portion of the negative electrode. The positive electrode and the negative electrode were spirally wound via a fine porous film separator made of polyethylene to produce a wound electrode assembly. This electrode assembly was housed in a bottomed cylindrical exterior housing can, the negative electrode lead was welded with a bottom inner face of the exterior housing can, and the positive electrode lead was welded with an internal terminal plate of a sealing assembly. Thereafter, the non-aqueous electrolyte was injected into the exterior housing can, and an end portion of an opening of the exterior housing can was caulked to the sealing assembly to produce a cylindrical test cell.

### [Evaluation of Adhesiveness of Positive Electrode Mixture Layer]

The above positive electrode was cut to produce a specimen with 15 mm in width and 80 mm in length. A double-sided tape (manufactured by Nitto Denko Corporation) was adhered to the positive electrode mixture layer of one surface of the specimen, and fixed on a stainless steel substrate having a smooth surface. The stainless steel substrate on which the specimen was fixed was placed so as to be horizontal. One end of the positive electrode current collector in a longitudinal direction of the specimen was fixed with a movable tool of a tensile tester (trade name: TENSILON Universal Testing Machine RTC1210, manufactured by A&D Company, Limited), and set so that the positive electrode current collector was to be peeled in a direction at 90° relative to the substrate surface of the stainless steel substrate. Then, the movable tool was moved to peel the positive electrode mixture layer and the positive electrode current collector in the specimen at a speed of 20 mm/min. In this time, the tensile direction was constantly retained to be at 90° relative to the substrate surface of the stainless steel substrate on which the specimen was fixed. A stable value of the tensile strength in peeling the specimen with greater than or equal to 30 mm was read to be specified as a peeling strength (N/m) of the positive electrode mixture layer from the positive electrode current collector.

### [Evaluation of Cell Discharge Capacity]

Under an environment temperature of 25° C., the test cell was charged at a constant current of 1 C until a battery voltage reached 4.2 V, and then charged at a constant voltage of 4.2 V until a current value reached 0.02 C. Thereafter, the test cell was discharged at a constant current of 1 C until the battery voltage reached 2.5 V. A discharge capacity at this time was specified as a cell discharge capacity.

### Example 1-2

A positive electrode and a test cell were produced and evaluated in the same manner as in Example 1-1 except that, in the production of the positive electrode, the first positive electrode active material and the second positive electrode active material were mixed so that the volume ratio V1/V2 was 6.1.

### Example 1-3

A positive electrode and a test cell were produced and evaluated in the same manner as in Example 1-1 except that, in the production of the positive electrode, the first positive electrode active material and the second positive electrode active material were mixed so that the volume ratio V1/V2 was 12.2.

### Example 1-4

A positive electrode and a test cell were produced and evaluated in the same manner as in Example 1-1 except that, in the production of the positive electrode, the linear pressure in rolling the coating film was lowered. A density of the positive electrode mixture layer was 3.45 g/cm³.

### Example 1-5

A positive electrode and a test cell were produced and evaluated in the same manner as in Example 1-1 except that, in the production of the positive electrode, the linear pressure in rolling the coating film was raised. A density of the positive electrode mixture layer was 3.55 g/cm³.

### Comparative Example 1-1

A test cell was produced and evaluated in the same manner as in Example 1-1 except that, in the production of the positive electrode, only the first positive electrode active material was used, and this was used as the positive electrode active material.

### Comparative Example 1-2

A test cell was produced and evaluated in the same manner as in Example 1-1 except that, in the production of the positive electrode, a lithium-transition metal composite oxide having an average particle diameter of 1.0 μm and composition represented by LiNi_{0.88}Co_{0.07}Al_{0.05}O₂ was used as the second positive electrode active material, and the first positive electrode active material and the second positive electrode active material were mixed so that the volume ratio V1/V2 was 7.2.

### Comparative Example 1-3

A positive electrode and a test cell were produced and evaluated in the same manner as in Example 1-1 except that, in the production of the positive electrode, the first positive electrode active material and the second positive electrode active material were mixed so that the volume ratio V1/V2 was 1.9.

### Comparative Example 1-4

A positive electrode and a test cell were produced and evaluated in the same manner as in Example 1-1 except that, in the production of the positive electrode, the linear pressure in rolling the coating film was further lowered than the case of Example 1-4. A density of the positive electrode mixture layer was 3.30 g/cm³.

### Examples 2-1 to 2-5 and Comparative Examples 2-1 to 2-4

Positive electrodes and test cells were produced and evaluated in respectively the same manner as in Examples 1-1 to 1-5 and Comparative Examples 1-1 to 1-4 except that, in the production of the positive electrode, the amount of the mixed PVDF was changed to 0.4 parts by mass relative to 100 parts by mass of the positive electrode active material.

Table 1 shows the evaluation results of the test cells of Examples and Comparative Examples. In Table 1, the results of the peeling strength and the discharge capacity of Examples 1-1 to 1-5 and 2-1 to 2-5 and Comparative Examples 1-2 to 1-4 and 2-1 to 2-4 are shown as values relative to respectively the peeling strength and the discharge capacity of the test cell of Comparative Example 1-1 being 100.

TABLE 1

| | Particle | Volume | Density of positive | | | |
|---|---|---|---|---|---|---|
| | diameter ratio | ratio | electrode mixture | Content of binder | Peeling | Discharge |
| | R1/R2 | V1/V2 | layer | [parts by mass] | strength | capacity |
| Example1-1 | 5.1 | 9.3 | 3.50 | 0.7 | 114 | 100.6 |
| Example2-1 | 5.1 | 9.3 | 3.50 | 0.5 | 106 | 100.9 |
| Example1-2 | 5.1 | 6.1 | 3.50 | 0.7 | 110 | 100.3 |
| Example2-2 | 5.1 | 6.1 | 3.50 | 0.5 | 101 | 100.5 |
| Example1-3 | 5.1 | 12.2 | 3.50 | 0.7 | 107 | 100.3 |
| Example2-3 | 5.1 | 12.2 | 3.50 | 0.5 | 100 | 100.5 |
| Example1-4 | 5.1 | 9.3 | 3.45 | 0.7 | 108 | 100.1 |
| Example2-4 | 5.1 | 9.3 | 3.45 | 0.5 | 100 | 100.3 |
| Example1-5 | 5.1 | 9.3 | 3.55 | 0.7 | 109 | 100.3 |
| Example2-5 | 5.1 | 9.3 | 3.55 | 0.5 | 101 | 100.5 |
| Comparative | — | — | 3.50 | 0.7 | 100 | 100 |
| Example1-1 | | | | | | |
| Comparative | — | — | 3.50 | 0.5 | 84 | 100.2 |
| Example2-1 | | | | | | |
| Comparative | 10.2 | 7.2 | 3.50 | 0.7 | 97 | 100.2 |
| Example1-2 | | | | | | |
| Comparative | 10.2 | 7.2 | 3.50 | 0.5 | 92 | 100.4 |
| Example2-2 | | | | | | |
| Comparative | 5.1 | 1.9 | 3.50 | 0.7 | 101 | 93.5 |
| Example1-3 | | | | | | |
| Comparative | 5.1 | 1.9 | 3.50 | 0.5 | 92 | 93.6 |
| Example2-3 | | | | | | |
| Comparative | 5.1 | 9.3 | 3.30 | 0.7 | 99 | 95.3 |
| Example1-4 | | | | | | |
| Comparative | 5.1 | 9.3 | 3.30 | 0.5 | 91 | 95.5 |
| Example2-4 | | | | | | |

All the test cells of Examples were better than the test cell of Comparative Example 1-1 in both of the peeling strength and the discharge capacity, and found to have excellent adhesiveness of the positive electrode mixture layer. Particularly, Example 2-1 exhibited remarkably improved peeling strength compared with Comparative Example 1-1 even when the amount of PVDF being the binder was reduced to 0.5 parts by mass.

The present disclosure will be further described with the following embodiments.

### Constitution 1:

A non-aqueous electrolyte secondary battery, comprising:
a positive electrode;
a negative electrode; and
a non-aqueous electrolyte, wherein
the positive electrode has a positive electrode current collector and a positive electrode mixture layer formed on a surface of the positive electrode current collector,
the positive electrode mixture layer includes a first positive electrode active material and a second positive electrode active material having a smaller average particle diameter than the first positive electrode active material,
a particle diameter ratio R1/R2 between an average particle diameter R1 of the first positive electrode active material and an average particle diameter R2 of the second positive electrode active material is greater than or equal to 3 and less than or equal to 9,
a volume ratio V1/V2 between a volume V1 of the first positive electrode active material and a volume V2 of the second positive electrode active material is greater than or equal to 3 and less than or equal to 15, and
a density of the positive electrode mixture layer is greater than or equal to 3.35 g/cm³ and less than or equal to 3.70 g/cm³.

### Constitution 2:

The non-aqueous electrolyte secondary battery according to Constitution 1, wherein
the particle diameter ratio R1/R2 is greater than or equal to 4 and less than or equal to 8,
the volume ratio V1/V2 is greater than or equal to 4 and less than or equal to 12, and
the density of the positive electrode mixture layer is greater than or equal to 3.40 g/cm³ and less than or equal to 3.65 g/cm³.

### Constitution 3:

The non-aqueous electrolyte secondary battery according to Constitution 1 or 2, wherein the first positive electrode active material and the second positive electrode active material are a lithium-transition metal composite oxide represented by the general formula LiₐNiₓM1_{y}M2_{z}O_{b}, wherein 0.9≤a≤1.2, 0.33≤x≤0.96, 0≤y≤0.67, 0≤z≤0.67, 1.9≤b≤2.1, x+y+z=1, M1 represents greater than or equal to one element selected from the group consisting of Co, Al, and Mn, and M2 represents greater than or equal to one element selected from the group consisting of Nb, Ti, Zr, W, and Si.

### REFERENCE SIGNS LIST

10 Secondary battery, 11 Positive electrode, 12 Negative electrode, 13 Separator, 14 Electrode assembly, 16 Exterior housing can, 17 Sealing assembly, 18, 19 Insulating plate, 20 Positive electrode lead, 21 Negative electrode lead, 22 Grooved portion, 23 internal terminal plate, 24 Lower vent member, 25 Insulating member, 26 Upper vent member, 27 Cap, 28 Gasket

1. A non-aqueous electrolyte secondary battery, comprising:
a positive electrode;
a negative electrode; and
a non-aqueous electrolyte, wherein
the positive electrode has a positive electrode current collector and a positive electrode mixture layer formed on a surface of the positive electrode current collector,
the positive electrode mixture layer includes a first positive electrode active material and a second positive electrode active material having a smaller average particle diameter than the first positive electrode active material,
a particle diameter ratio R1/R2 between an average particle diameter R1 of the first positive electrode active material and an average particle diameter R2 of the second positive electrode active material is greater than or equal to 3 and less than or equal to 9,
a volume ratio V1/V2 between a volume V1 of the first positive electrode active material and a volume V2 of the second positive electrode active material is greater than or equal to 3 and less than or equal to 15, and
a density of the positive electrode mixture layer is greater than or equal to 3.35 g/cm³ and less than or equal to 3.70 g/cm³.

2. The non-aqueous electrolyte secondary battery according to claim 1, wherein
the particle diameter ratio R1/R2 is greater than or equal to 4 and less than or equal to 8,
the volume ratio V1/V2 is greater than or equal to 4 and less than or equal to 12, and
the density of the positive electrode mixture layer is greater than or equal to 3.40 g/cm³ and less than or equal to 3.65 g/cm³.

3. The non-aqueous electrolyte secondary battery according to claim 1, wherein the first positive electrode active material and the second positive electrode active material are a lithium-transition metal composite oxide represented by the general formula LiₐNiₓM1_{y}M2_{z}O_{b}, wherein 0.9≤a≤1.2, 0.33≤x≤0.96, 0≤y≤0.67, 0≤z≤0.67, 1.95≤b≤2.1, x+y+z=1, M1 represents greater than or equal to one element selected from the group consisting of Co, Al, and Mn, and M2 represents greater than or equal to one element selected from the group consisting of Nb, Ti, Zr, W, and Si.
